(19) United States
(12) Patent Application Publication
(10) Pub. No.: US 2024/0302953 A1
(43) Pub. Date: Sep. 12, 2024

(54) CONTENT DISPLAY METHOD

(71) Applicant: Panasonic Automotive Systems Co., Ltd., Kanagawa (JP)

(72) Inventors: Takuma MASUDA, Kanagawa (JP); Yukimasa KOMIYA, Kanagawa (JP); Tsuyoshi NISHIO, Chiba (JP); Toshihiro MIYAMICHI, Kanagawa (JP)

(73) Assignee: Panasonic Automotive Systems Co., Ltd., Kanagawa (JP)

(21) Appl. No.: 18/665,695

(22) Filed: May 16, 2024

Related U.S. Application Data
(63) Continuation of application No. PCT/JP2022/027148, filed on Jul. 8, 2022.

(30) Foreign Application Priority Data
Nov. 30, 2021 (JP) 2021-194160

(51) Int. Cl. G06F 3/04883; G06F 3/041; G06F 3/04817; G06F 3/0486

(52) U.S. Cl. CPC G06F 3/04883; G06F 3/0412; G06F 3/04817; G06F 3/0486

(57) ABSTRACT

According to the present disclosure, a content display method of a display device, which includes: a display having a predetermined shape and having a predetermined side along a first direction; and a touch panel arranged to overlap the display and configured to receive a touch operation, includes: displaying a first content on the display; receiving a first touch operation along the first direction on the touch panel; moving the first content along the first direction and moving an index serving as a second content related to the first content along the first direction near the predetermined side, on the display; receiving a second touch operation along a second direction different from the first direction on the touch panel, the second touch operation starting from a position corresponding to the index; and displaying the second content on the display.

### CROSS-REFERENCE TO RELATED APPLICATIONS

This application is a continuation of International Application No. PCT/JP2022/027148, filed on Jul. 8, 2022 which claims the benefit of priority of the prior Japanese Patent Application No. 2021-194160, filed on Nov. 30, 2021, the entire contents of which are incorporated herein by reference.

### FIELD

Embodiments described herein relate generally to a content display method.

### BACKGROUND

Conventionally, a messenger has been used as a tool for conversation with a communication counterpart. In the messenger, texts, images, and the like posted from terminals used by the respective users are displayed in line in time series in a vertical direction of a screen. For this reason, the messenger is widely used, because a user can enjoy a conversation with a communication counterpart in real time, and can trace a screen with a finger in a vertical direction to quickly check a past conversation in time series.

Note that, as a technology related to a messenger, there is disclosed a technology for transmitting a brand image of an advertiser selected by a user to a conversation counterpart (e.g., JP 2015-520446 A). In addition, there is disclosed a technology for sharing an image in a group by a messenger function (e.g., JP 2019-192258 A).

The present disclosure provides a content display method capable of improving operability when displaying a second content related to a first content such as a conversation.

### SUMMARY

According to an embodiment of the present disclosure, a content display method of a display device, which includes: a display having a predetermined shape and having a predetermined side along a first direction; and a touch panel arranged to overlap the display and configured to receive a touch operation, includes: displaying a first content on the display; receiving a first touch operation along the first direction on the touch panel; moving the first content along the first direction and moving an index serving as a second content related to the first content along the first direction near the predetermined side, on the display; receiving a second touch operation along a second direction different from the first direction on the touch panel, the second touch operation starting from a position corresponding to the index; and displaying the second content on the display.

### BRIEF DESCRIPTION OF THE DRAWINGS

FIG. 1 is a diagram illustrating an example of a schematic configuration of a content display system according to an embodiment;

FIG. 2 is a diagram illustrating an example of a hardware configuration of a terminal according to the embodiment;

FIG. 3 is a diagram illustrating an example of a functional block configuration of the terminal according to the embodiment;

FIG. 4 is a diagram illustrating an example of a method of displaying a second content on a display of the terminal according to the embodiment;

FIG. 5 is a diagram illustrating an example of a procedure of a display flow in which the terminal displays contents on the display according to the embodiment;

FIG. 6 is a diagram illustrating an example of a control flow in which an index is displayed according to the embodiment;

FIG. 7 is a diagram illustrating an example of a flow of dynamic processing according to the embodiment;

FIG. 8 is a diagram for explaining the dynamic processing according to the embodiment;

FIG. 9 is a flowchart illustrating an example of a procedure in which the terminal arranges an index on a display screen according to the embodiment;

FIG. 10 is a diagram (part 1) for explaining a method of arranging an index according to the embodiment; and

FIG. 11 is a diagram (part 2) for explaining a method of arranging an index according to the embodiment.

### DETAILED DESCRIPTION

Hereinafter, a content display method according to an embodiment of the present disclosure will be described in detail with reference to the accompanying drawings.

### Embodiment

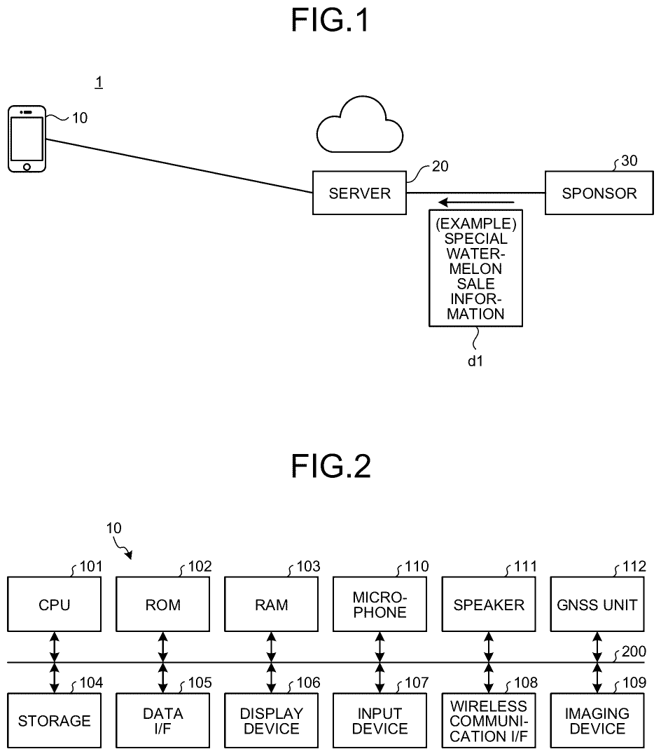

FIG. 1 is a diagram illustrating an example of a schematic configuration of a content display system according to an embodiment. The content display system 1 illustrated in FIG. 1 includes a terminal 10 that displays contents and a server 20 as components. Although one terminal 10 is illustrated in FIG. 1, the number of terminals 10 connected to the server 20 is not limited to one.

The terminal 10 corresponds to a display device including a display capable of displaying contents and a touch panel arranged to overlap the display and receive a touch operation. As an example of the terminal 10, a smartphone, a tablet terminal, or the like can be used.

A user uses a messenger function online or offline on the own terminal 10. In a case where the user uses the messenger function online with a user in the same group, the terminal 10 of the user connects to the Internet using 4G, 5G, or the like of a mobile communication system or Wi-Fi (registered trademark), activates the messenger function, and transmits and receives characters (hereinafter referred to as text) or images and the like (referred to as a first content) to and from terminals 10 of a plurality of other users via the server 20 to share them.

The server 20 is a server having a messenger function, and is provided in, for example, a cloud. The server 20 distributes the first content randomly posted from the plurality of terminals 10 of the same group to each terminal 10 in the group in the same time series.

Note that the server 20 may have a configuration to distribute sponsor information to the terminals 10 based on the sponsor information from a sponsor 30. For example, the sponsor 30 is a business operator of a supermarket, and registers store information on the server 20 from a terminal of the business operator. The store information is a location, an appearance, special sale information for a certain period of time, and the like of the store. Furthermore, a server for sponsors may be separately provided, sponsor information such as special sale information for each region of the country may be aggregated on the server for the sponsors, and the server 20 may automatically acquire the sponsor information corresponding to the terminal 10 by, for example, inquiring the sponsor server.

FIG. 2 is a diagram illustrating an example of a hardware configuration of the terminal 10. FIG. 2 illustrates a basic hardware configuration of a smartphone (or tablet).

The terminal 10 illustrated in FIG. 2 is a computer in which a central processing unit (CPU) 101, a read only memory (ROM) 102, and a random access memory (RAM) 103 are connected to a bus 200. Further, a storage 104, a data I/F 105, a display device 106, an input device 107, a wireless communication I/F 108, an imaging device 109, a microphone 110, a speaker 111, and a GNSS unit 112 are connected to the bus 200.

The CPU 101 executes programs stored in the ROM 102 and the storage 104 to control the entire terminal 10. The RAM 103 is used as a work area by the CPU 101.

The storage 104 is a non-volatile storage medium that stores programs to be executed by the CPU 101 and various data. For example, the storage 104 is a non-volatile semiconductor memory such as a flash memory.

The data I/F 105 is an interface such as USB or Bluetooth (registered trademark) that inputs and outputs data to and from an external device or an external memory.

The display device 106 is a display device such as a liquid crystal display (LCD) or an organic electro luminescence (EL) that displays screen information.

The input device 107 is a device that receives a key operation or a touch operation performed by the user. In the present embodiment, the input device includes a touch panel configured to overlap a screen of the display device 106. The touch panel receives a touch operation performed by the user on the screen by detecting a touch position of the user on the screen of the display device 106 in a capacitance type. The type of the touch panel may be an electromagnetic induction type, an infrared type, a resistive film type, a surface acoustic wave type, or the like, as well as the capacitance type.

The wireless communication I/F 108 is, for example, a wireless communication I/F such as 4G, 5G, or Wi-Fi, and communicates with a 4G or 5G radio base station, a Wi-Fi access point, or the like.

The imaging device 109 includes an imaging sensor such as a charge-coupled device (CCD) or a complementary MOS (CMOS), captures an image of a subject by the imaging sensor, and outputs the captured image to the storage 104 or the external memory.

The microphone 110 inputs a sound as an electric signal. For example, a voice or the like of the user is converted into an electric signal and the electric signal is input during a telephone conversation.

The speaker 111 outputs a sound. For example, a voice file registered in the terminal 10 is reproduced and output, or a voice signal of a counterpart during a telephone conversation is converted into a sound and the sound is output.

The GNSS unit 112 acquires a current position (coordinate information) by a global navigation satellite system (GNSS).

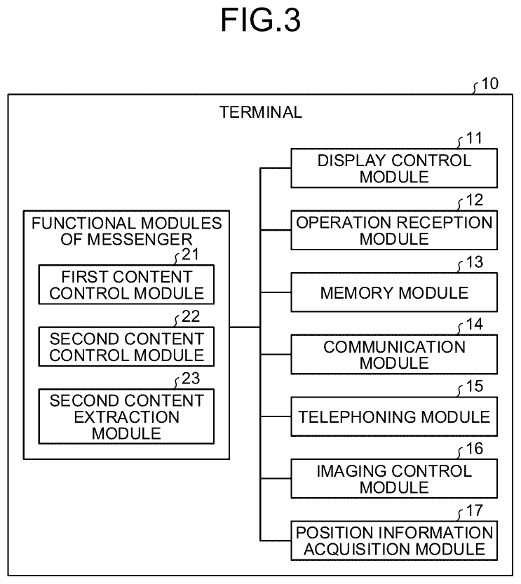

FIG. 3 is a diagram illustrating an example of a functional block configuration of the terminal 10. As illustrated in FIG. 3, the terminal 10 includes a display control module 11, an operation reception module 12, a memory module 13, a communication module 14, a telephoning module 15, an imaging control module 16, a position information acquisition module 17, and the like which are included in the smartphone or the like as basic functions. Furthermore, the terminal 10 includes a first content control module 21, a second content control module 22, and a second content extraction module 23 as main functions of the messenger according to the present embodiment.

The CPU 101 performs these various functions by executing a predetermined program stored in the storage 104 or the like. Here, each function is illustrated as a module, but it is needless to say that each function may be in a form other than the module.

The display control module 11 outputs the generated screen information to the display device 106.

The operation reception module 12 receives a touch operation performed on the touch panel by the user based on a touch position signal output from the touch panel. For example, when the user touches one point on the screen, the operation reception module 12 receives the touch position. In addition, when the user traces the screen with a finger, the operation reception module 12 calculates in which direction and by what amount the finger has moved on the screen from the movement of the touch position of the finger. In addition, when the user performs a touch operation called a flick by flicking the screen with a finger in a specific direction after placing the finger at one point, the operation reception module 12 calculates the direction in which the screen is flicked with the finger and a speed at which the screen is flicked with the finger.

The memory module 13 stores data in a designated destination and reads the stored data from the designated destination. The memory module 13 stores, for example, an image, first content information such as a past conversation for each group exchanged by the messenger, behavior history information, and the like in the designated destination. The designation destination is, for example, the storage 104. The image is an image captured by the imaging device 109 or an image in the external memory or the like. As an example, the image is a photographic image. The behavior history information is behavior history information in which position information, time information, and the like acquired from the GNSS unit 112 are stored. The behavior history information may include information such as atmospheric temperature, temperature, and weather.

The communication module 14 is connected to an access point or a radio base station via the wireless communication I/F 108 to communicate with the server 20 or the like.

The telephoning module 15 enables a telephone conversation with a counterpart terminal via the wireless communication I/F 108.

The imaging control module 16 captures an image using the imaging device 109.

The position information acquisition module 17 acquires current position information and time information from the GNSS unit 112.

The first content control module 21 controls a display of the messenger. For example, the first content control module 21 controls a display of a first content such as a text and an image to be displayed on the display screen of the messenger, a text input key, and the like. The first content control module 21 performs control to move the display of the first content in a first direction on the display screen of the messenger to add a new post to an empty area, or move the display of the first content in the first direction when the user performs a scroll operation.

The second content control module 22 controls a display of a second content on the display screen. For example, the second content control module 22 displays an index that is a second content or switches to an image associated with the index on the display screen that displays the first content. The second content control module 22 displays the index or switches to the image associated with the index on a layer different from the screen that displays the first content, and outputs screen information obtained by synthesizing the content displayed as the second content on the display screen that displays the first content to the display control module 11. Note that the second content is not limited to an index or an image, and may be in another form.

The second content extraction module 23 specifies a topic from the messenger conversation content displayed on the display screen of the messenger by the first content control module 21, and extracts the specified topic and related information related to the specified topic. In this example, the related information is an index or an image that is the second content.

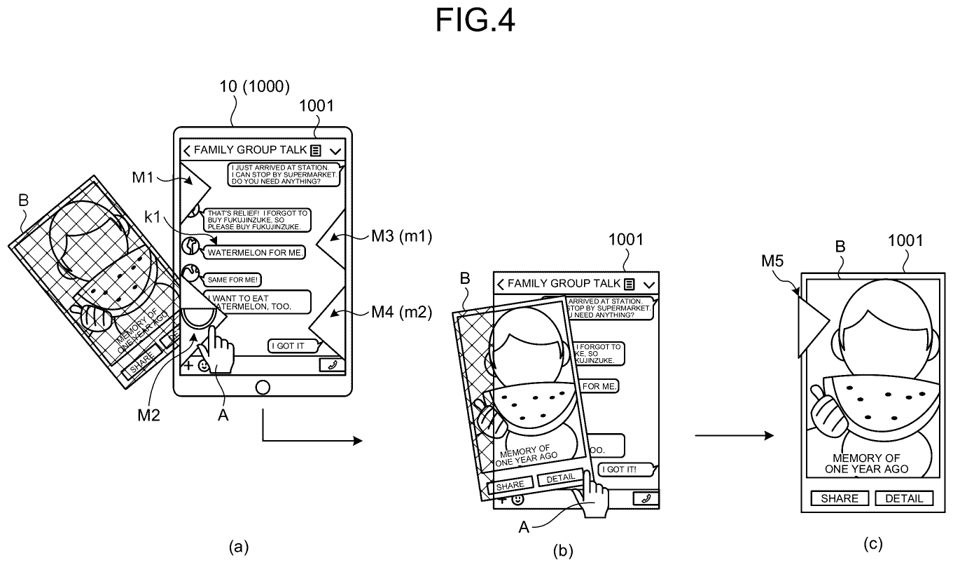

FIG. 4 is a diagram illustrating an example of a method of displaying a second content on the display of the terminal 10. A display 1000 and a display screen 1001 illustrated in FIG. 4 is rectangular, and is used in a vertical state where their long sides are disposed vertically as an example. In the smartphone and the tablet terminal, since the upward and downward orientations of the terminal 10 can be recognized by an acceleration sensor or the like. Thus, by changing the orientation of the terminal 10 from vertical to horizontal, the content displayed on the display screen 1001 is reversed by 90° with respect to the terminal 10 to be orientated upright with respect to the user, so that the terminal 10 can also be used horizontally. In this example, in order to make the explanation easy to understand, an example in which the terminal 10 is placed vertically is illustrated.

The display 1000 illustrated in FIG. 4 has a rectangular display screen 1001, and is used with its long sides are disposed vertically. That is, the display screen 1001 is oriented in such a manner that the long sides are disposed vertically with respect to the direction in which the user stands upright. On the display screen 1001, the second content (index M (M1, M2, . . . )) is displayed in preference to the display information (such as balloon k1) of the first content. Note that, since the background area other than the index M and the image B serving as the second content is a transparent layer, the information of the first content, that is, a plurality of posts (conversation contents) such as balloons k1 arranged in the vertical direction, remains displayed in the background area other than the index M and the image B.

In FIG. 4, a conversation flows about watermelon, which is a topic as the information of the first content on the display screen 1001 of FIG. 4(a). On the display screen 1001, the conversation flows along its long sides. Hereinafter, the direction in which the conversation flows is referred to as from top to bottom. In addition, left and right are represented based on the direction in which the conversation flows. On the display screen 1001, the lower content of the conversation is newer, and the old conversation moves up in order. At the timing of conversation shown on the display screen 1001, since users are talking about watermelon by the messenger, it is possible to specify that the topic is “watermelon” by the second content extraction module 23 analyzing the content (text) of the messenger conversation in the background. With reference to FIG. 4, a method of displaying a second content will be described with “watermelon” being a topic as an example.

In the display screen 1001 of FIG. 4(a), the index M (M1, M2, M3, and M4) is inserted as the second content in the display information of the messenger. Although the index M is attached in any form, a triangular-shaped index is attached here as an example. The form of the index M is not limited to the triangular shape, and may be another shape such as a square and a circle, a symbol, or the like.

The index M is preferably arranged in an empty space of a posting area for the subject person using the terminal 10 in order to notify the subject person of related information that is a topic of the conversation. For example, in a case where the display screen 1001 is set such that posts for the subject person are lined up along the left side of the display screen 1001, the index M, namely, an index M1 and an index M2 in the example illustrated in FIG. 4(a) are arranged in the empty space of the conversation along the left side.

Note that the index M is preferably arranged near the side (the long side in this example). If the topic is watermelon, an icon indicating the watermelon is used as the index, as indicated by the index M2, so that the topic can be recognized at a glance. When there is another topic in addition to the watermelon, the index for the watermelon and the index for another topic are displayed on the same screen in different arrangements (indexes M1 and M2). If there are three or more topics, the respective indexes are displayed in different arrangements.

In addition, although the index M is arranged on the side for the subject person, but is not limited thereto. If there is no empty space in the posting area for the subject person, indexes may be arranged in posting areas for a counterpart, that is, empty spaces of the conversation on the right side opposite to the left side of the display screen 1001, like indexes m1 and m2. In addition, indexes may be arranged on both the left side and the right side.

Furthermore, if there is no empty space, an operation of setting a post interval in the content displayed as the first content of the messenger or the like may be performed to provide an empty space corresponding to the index M.

In addition, the index M is not limited to the icon. A partial portion (e.g., a corner portion) of the image B to be displayed as the second content may be displayed as the index M. In this case, it is preferable that the index M is particularly arranged in contact with the left side of the display screen 1001.

Here, when the user touches the screen 1001 and traces or flicks the screen with a finger A in the direction along the side (corresponding to the first direction), it is detected as a first touch operation, and the index M moves together with the first content in that direction. For example, in a case where it is desired to check the content of the conversation so far, when the user flicks the screen 1001 with the finger A from top to bottom along the long side in the first direction, both a past conversation hidden above the screen 1001 and a past index M move down and are displayed in the screen 1001. In this manner, the direction of the first touch operation along the first direction, the direction of the movement of the first content (posts lined up in time series) along the first direction, and the direction of the movement of the index M along the first direction are the same.

Next, the user touches the index M2 in FIG. 4(a) with the finger A, and performs a second touch operation which is an operation of flicking the index M2 in a second direction different from the direction along the side (the first direction). Then, the second touch operation is detected, the image B corresponding to the index M2 slides in the display screen 1001 as illustrated in FIG. 4(b), and the image B is displayed on the entire screen of the display screen 1001 as illustrated in FIG. 4(c). In this example, the index M2 is an icon indicating watermelon. In a case where a corner of a past photographic image related to watermelon is used as the index M2, when the user flicks the corner, the entire image B is gradually displayed from the corner image. It is needless to say that, if the index M2 is an icon, the image B associated with the icon slides in. Note that the sliding-in method is an example, and the method of displaying the image B in the entire screen after flicking the index M2 may be appropriately set.

In addition, the size and the residence time of the index M displayed on the display screen 1001 are set according to the amount of the topic. For example, as the conversation progresses, the index M also moves in the upward direction along with the flow of the conversation, and the index M becomes outside the display screen 1001. However, even though the index M still remains in the display screen 1001, when the index M no longer becomes a topic, the icon is reduced or the icon is removed from the display screen 1001. The index M1 is an example of a large icon, and the index M2 is an example of a small icon. Furthermore, in a case where the amount of the topic is large, the index M may be left in place, rather than moving along with the flow of the conversation in the upward direction in which the conversation flows.

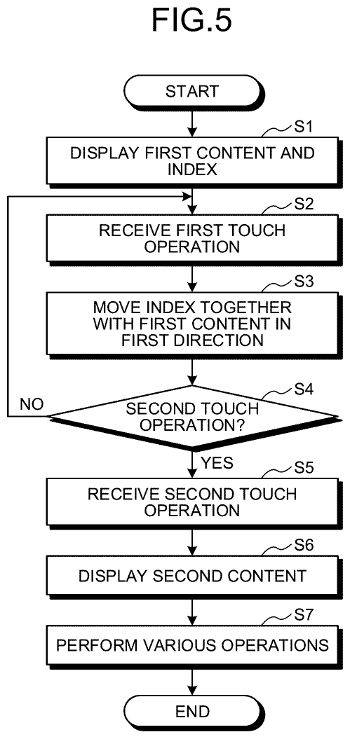

FIG. 5 is a diagram illustrating an example of a procedure of a display flow in which the terminal 10 displays contents on the display 1000. After the messenger functions are activated, the terminal 10 displays an input screen of the messenger on the display screen 1001 of the display 1000, and displays a first content on the display screen 1001 by receiving an input of the first content or the like (step S1). The terminal 10 displays a first content input by the user and a first content input by a communication counterpart as the first content on the display screen 1001 in time series. Since the display area is restricted, the terminal 10 updates the display every time a first content is input, and displays contents of a conversation or the like in a predetermined range backward from the most recently input first content in time series on the display screen 1001. Furthermore, in the present embodiment, the terminal 10 specifies a topic from the contents of the conversation, and displays an index M for the specified topic in an empty space. Here, as an example, it is assumed that posts of the user are arranged in time series along a vertical side of the screen 1001 of the display 1000, and an index M is added near the vertical side of the screen 1001.

When the user traces the screen 1001 in the direction along the vertical side (corresponding to the first direction) with the finger A, the terminal 10 receives a first touch operation along the first direction on the touch panel (step S2).

Then, on the display screen 1001, the terminal 10 moves the first content along the first direction and moves the index M related to the first content near a predetermined side along the first direction (step S3).

Next, when the user traces or flicks the index M on the screen 1001 with the finger A in a second direction different from the first direction (step S4: Yes), the terminal 10 receives a second touch operation starting from a position corresponding to the index M along the second direction on the touch panel (step S5).

When receiving the second touch operation, the terminal 10 displays a second content on the display screen 1001 (step S6). The second content in this case is not the index M but a photographic image such as the image B associated with the index M.

After step S3, when the user traces the screen 1001 in the first direction without performing any operation of tracing or flicking the index M in the second direction (step S4: No), the terminal 10 repeats the procedure from step S2.

When receiving a next operation after displaying the image B (the photographic image in this example) in step S6, the terminal 10 ends the display of the image B (the photographic image) and performs display based on the next operation (step S7). The next operation is, for example, an operation of closing the image B (the photographic image). The terminal 10 may receive an operation of closing the image B (photographic image) by an operation of touching a close button provided as screen information, by an operation of flicking the index M in a direction opposite to the direction of the second touch operation, or the like. When such an operation is performed, the terminal 10 ends the display of the image B (the photographic image) and returns to the screen for displaying a first content and an index M. Thereafter, the terminal 10 returns to step S2, and closes the screen and returns to the home screen when an end operation is received.

Note that, as an example, the terminal 10 displays the index and the photographic image related to the topic as the second content, but may display an index M5 for a sponsor to which both the region of the position of the terminal 10 and the topic correspond. For example, in a case where the topic is “watermelon”, the terminal 10 receives, from the server 20, special watermelon sale information d1 for a nearby supermarket provided from the sponsor 30, and the like, and adds the received information as the index M5. The index M5 may be added to the image B (the photographic image). In a case where the terminal 10 receives an operation of touching the index M5 for the sponsor as the next operation in step S7, the terminal 10 displays sponsor information associated with the index M5 for the sponsor. The sponsor information may be, for example, map information indicating the position of the supermarket or a discount coupon, or may be arbitrarily set.

Furthermore, as a method of displaying the sponsor information, a sliding-in method based on a flicking operation or the like may be applied, similarly to the photographic image.

Control Flow in which Index M is Displayed

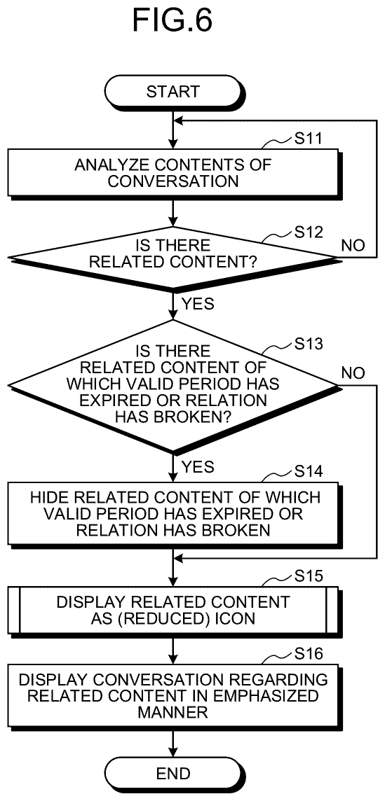

FIG. 6 is a diagram illustrating an example of a control flow in which the index M is displayed. First, the terminal 10 (the second content extraction module 23) analyzes contents of a conversation performed by the messenger (step S11). The terminal 10 (the second content extraction module 23) analyzes texts in order from the beginning of the conversation, for example, after the messenger is activated, and specifies a word having a particularly high hit rate among words appearing in the latest conversation as a topic.

Further, the terminal 10 (the second content extraction module 23) determines whether there is a related content related to the specified topic (step S12). The form of the related content is not particularly limited, but the form of the related content is image data herein as an example, and mainly, a photographic image of a user stored in the terminal 10.

The terminal 10 (the second content extraction module 23) extracts the corresponding photographic image from the memory module 13. Whether or not the photograph corresponds to the topic may be determined on the basis of picture management information (file name, title, date and time, etc.), or may be determined from the photographic image itself. For example, the second content extraction module 23 can use a trained model subjected to machine learning for determination. A photographic image is input to the trained model, and a word learned in advance is output. For example, an image of “watermelon” is learned, and when there is a photographic image including an image of “watermelon”, a matching rate of “watermelon” is output.

When there is no related content related to the specified topic (step S12: No), the terminal 10 (the second content extraction module 23) returns to step S11, analyzes the contents of the conversation which are sequentially updated, and specifies a word having a particularly high hit rate among words appearing in the latest conversation as a topic. Note that the topic determined as No in step S12 may be excluded for a certain period, for example, for a period until the messenger is closed.

When there is a related content related to the specified topic (step S12: Yes), the terminal 10 (the second content extraction module 23) determines whether the valid period of the related content has expired or whether the relation of the related content has broken (step S13). When the valid period of the related content has expired or when the relation of the related content has broken (step S13: Yes), the terminal 10 (the second content control module 22) hides the subject related content (step S14).

In addition, when the related content is valid and the relation of the related content has not broken (step S13: No), the terminal 10 (the second content control module 22) dynamically processes and displays an index M (such as an icon) for the subject related content (step S15).

Here, the broke of the relation refers to a state in which the content of the displayed conversation is not associated with the related content when the conversation progresses or the messenger is scrolled up or down by the first touch operation. Therefore, in steps S14 and S15, the terminal 10 (the second content control module 22) displays the index M2 for watermelon when the topic is watermelon, but hides the index M2 for watermelon when the conversation further progresses and the talk about watermelon disappears from the screen. In addition, when the terminal 10 (the first content control module 21) re-displays the past talk about watermelon by scrolling up and down or the like, the terminal 10 (the second content control module 22) re-displays the index M2 for watermelon.

The terminal 10 (the second content control module 22) dynamically processes the index M in step S15, and displays, for example, a reduced icon. Note that the method of displaying the index M is not limited to this method, and may be appropriately determined.

Next, the terminal 10 (the first content control module 21) displays the conversation regarding the related content, that is, the word indicating the topic, in an emphasized manner (step S16). The terminal 10 (the first content control module 21) displays the word indicating the topic, for example, in a color, a size, or the like different from those of the other texts as the emphasized display.

The terminal 10 repeats steps S11 to S16 after the start of the messenger until the end of the messenger. The repetition timing may be arbitrarily set. As an example, steps S11 to S16 are repeated at a timing when the conversation progresses or the messenger is scrolled up or down by the first touch operation.

Note that, here, the photographic image has been described as an example of the related content, but in a case where there is sponsor information, the sponsor information is also included in the related content. In a case where sponsor information (discount information, special sale information d1, and the like) from a sponsor corresponding to the topic is acquired from the server 20, a determination is also made with respect to the sponsor information.

The expiration of the valid period in step S13 mainly means that the valid period of the sponsor information has expired. For example, in a case where the candidate for the sponsor information associated with “watermelon” as the second content is coupon information for which a discount period has expired, the sponsor information is hidden because the valid period of the sponsor information has expired. The related content to be hidden may be only the sponsor information, or the photographic image associated with the sponsor information, that is, the index itself, may be hidden.

The terminal 10 determines which sponsor information is to be associated on the basis of the behavior history information of the terminal 10, the topic such as watermelon, or the like. For example, the association may be performed by the terminal 10 making an inquiry to the server 20, or the server 20 may transmit the topic and the corresponding sponsor information in association with each other to the terminal 10 on the basis of the region of the terminal 10 and the topic.

### Hit Rate

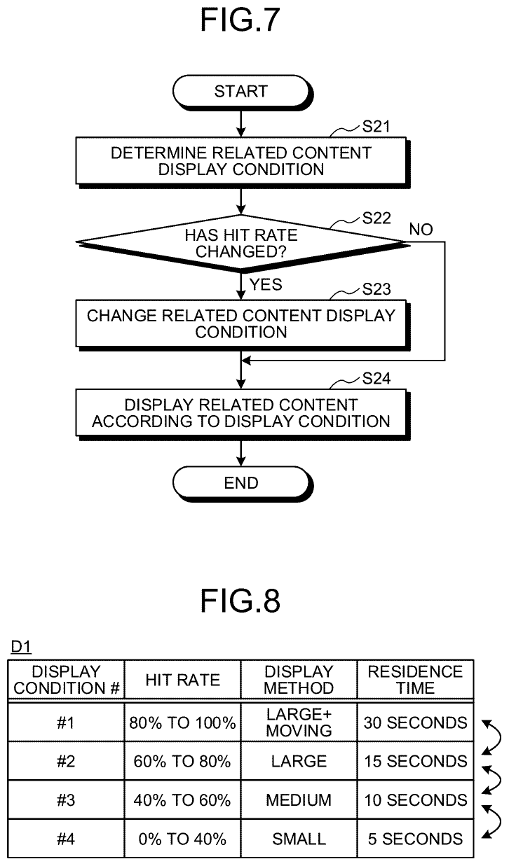

FIG. 7 is a diagram illustrating an example of a flow of dynamic processing in step S15. FIG. 8 is a diagram for explaining the dynamic processing. Hereinafter, the dynamic processing will be described with reference to FIGS. 7 and 8.

Since the topic changes in real time according to the content of the conversation, the terminal 10 dynamically changes the display method and the residence time according to the hit rate of the latest topic. For example, as the conversation progresses, the number of times the topic “watermelon” appears changes. At first, the number of times “watermelon” appears was small, but the number of times “watermelon” appears gradually increases and becomes a topic. When the topic is exciting, the number of times “watermelon” appears satisfies the maximum condition. Thereafter, when the topic is changed to another topic, the number of times “watermelon” appears gradually decreases, and finally, the topic disappears. The processing in which the terminal 10 dynamically changes the method of displaying the index M for “watermelon” according to the excitement about the topic is dynamic processing. As an example, the terminal 10 determines the excitement about the topic with stepwise conditions provided as illustrated in FIG. 8, and dynamically changes the display of the index M according to how the “topic” is exciting.

FIG. 8 illustrates dynamic display settings D1 when conditions are classified into four stages from “#1” to “#4”. The condition “#4” is a setting for a case where the number of times “watermelon” appears is small. In the condition “#4”, the hit rate of the word “watermelon” is set from 0% to 40%. The hit rate is set to be high in the order of “#3” and “#2”, and the hit rate of the word “watermelon” in the condition “#1” is set from 80% to 100% which is highest.

Since a higher hit rate indicates that the topic is more exciting, the terminal 10 displays the index M2 for “watermelon”, the icon for “watermelon” in this example, from “small” to “medium” and from “medium” to “large” in the (upward) order of the arrows in FIG. 8 in an enlarged manner. In addition, the terminal 10 changes the setting to “moving” in which the icon for “watermelon” is moved in the condition “#1” with the highest hit rate of from 80% to 100%.

The terminal 10 also changes the residence time of the displayed icon. The residence time is a time for which the icon is displayed on the display screen. For example, the icon with the size of “medium” displayed in #3 is displayed for 10 seconds. However, the conversation progresses in real time. In a case where the topic “watermelon” is no longer exciting even though the conversation progresses, the icon is reduced to an icon with the size of “small” after 10 seconds in the (downward) order of the arrows in FIG. 8, and if the topic is not exciting thereafter, the icon is hidden after 5 seconds. On the other hand, when the topic “watermelon” becomes exciting, the condition becomes from #4 to #3 and from #3 to #2 in the (upward) order of the arrows in FIG. 8, and the icon becomes enlarged and has a larger size, and the residence time is also set to be long. Then, when the condition becomes #1, the residence time is set to 30 seconds, and even when the conversation flows on the display screen, that is, even when the latest conversation is added and the old conversation moves up, the icon remains in place for 30 seconds without flowing with the conversation by setting “large+moving”.

Note that when the hit rate decreases during the display of the icon and the condition is changed to one of #2 to #4, the residence time is also changed at that timing. As an example, assuming that the timing at which “watermelon” is specified as the topic is t, the hit rate and the display condition are as follows.
t=0 seconds: when the hit rate is 20%, the display condition is #4 (remaining time: 5 seconds)
t=1 second: when the hit rate is 20%, the display condition is #4 (remaining time: 4 seconds)
t=2 seconds: when the hit rate is 60%, the display condition is #3 (remaining time: 10 seconds), and at this time, the residence time is reset.
t=10 seconds: when the hit rate is 65%, the display condition is #2 (remaining time: 7 seconds)
t=11 seconds: when the hit rate is 55%, the display condition is #3 (remaining time: 6 seconds) and the shorter residence time is set.

As illustrated in FIG. 7, the terminal 10 first determines a related content display condition (step S21), and determines whether the hit rate has changed (step S22). The terminal 10 determines which one of #1 to #4 the current display corresponds to. Then, when the latest hit rate of the topic “watermelon” specified from the conversation by the analysis changes and the display condition changes, the terminal 10 determines step S22 (Yes). Whether to change the display condition is determined from the settings in the table of FIG. 8.

When the hit rate has changed (step S22: Yes), the terminal 10 changes the related content display condition (step S23), and displays the related content according to the changed display condition (step S24).

When the hit rate has not changed (step S22: No), the terminal 10 displays the related content according to the display condition as it is without changing the related content display condition (step S24).

### Method of Arranging Index M

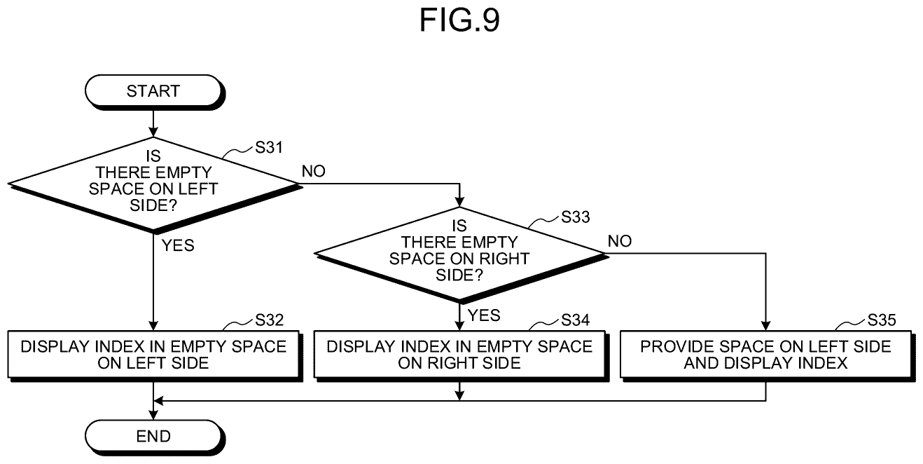

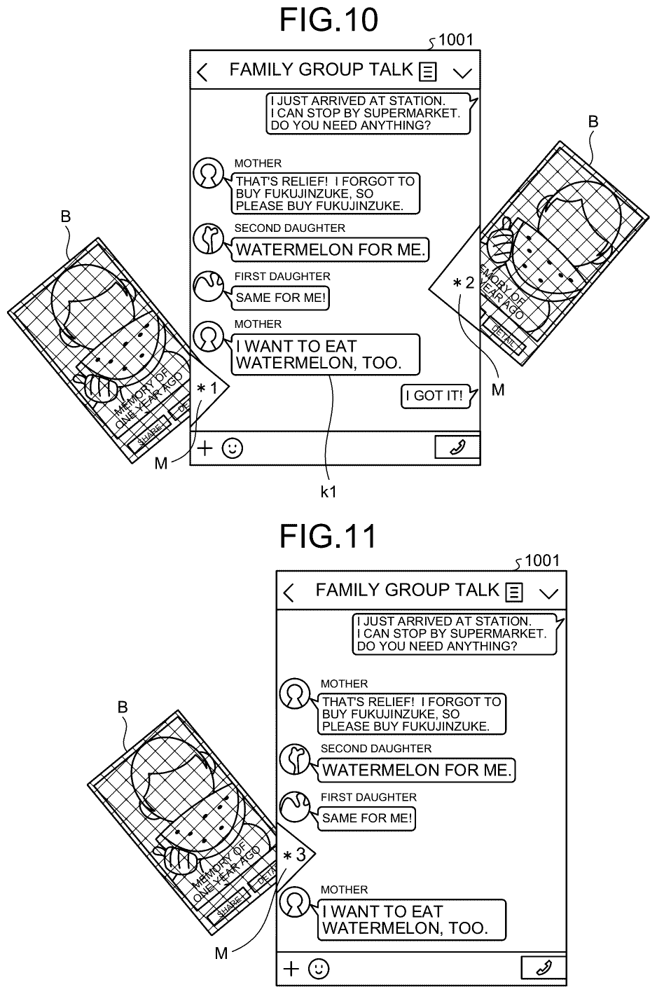

FIG. 9 is a flowchart illustrating an example of a procedure in which the terminal 10 (the second content control module 22) arranges an index on the display screen. FIGS. 10 and 11 are diagrams for explaining a method of arranging an index. The procedure of arrangement of FIG. 9 will be described with reference to FIGS. 10 and 11.

First, the terminal 10 determines whether there is an empty space on the left side of the display screen 1001 (step S31). When there is an empty space on the left side of the display screen 1001 (step S31: Yes), the index M is displayed in the empty space on the left side of the display screen 1001 (step S32). In an example of a screen illustrated in FIG. 10, since there is an empty space on the left side, the index M is arranged in the empty space.

When there is no empty space on the left side of the display screen 1001 (step S31: No), the terminal 10 determines whether there is an empty space on the right side of the display screen 1001 (step S33). When there is an empty space on the right side of the display screen 1001 (step S33: Yes), the index M is displayed in the empty space on the right side of the display screen 1001 (step S34). When there is no empty space on the left side of the screen illustrated in FIG. 10, the index M is arranged in the empty space on the right side.

When there is no empty space on the right side of the display screen 1001 (step S33: No), the terminal 10 provides an empty space on the left side of the display screen 1001 and displays the index M (step S35).

FIG. 11 illustrates an example in which the terminal 10 provides an empty space on the left side of the display screen 1001 and displays the index M. In the example of the screen illustrated in FIG. 10, there is no empty space at the corresponding location. Therefore, as illustrated in FIG. 11, the terminal 10 arranges the index by providing an empty space, for example, by providing an interval in the messenger conversation (such as balloon k1).

Note that the terminal 10 may have an agent function that interacts with the user, and the agent function may be linked with the messenger function according to the present embodiment. For example, when the user talks to the agent and asks about food, if the topic “watermelon” has been extracted by the messenger function, the agent answers “why don't you prepare watermelon?” by voice.

In the content display system according to the present embodiment, conversation contents on the messenger is analyzed, a related content is displayed with an index attached to an empty space of the conversation on the messenger, and the details of the related content can be checked on the messenger only by flicking the index in a direction different from the direction in which the conversation flows, so that the operability is improved. In addition, since the index is displayed as an icon and the size of the icon is dynamically changed according to the excitement about the topic, the visibility is also improved.

Furthermore, conventionally, in a case where an advertisement is displayed, the advertisement is a regional targeting advertisement using position information, an action targeting advertisement using a browsing history, or the like, but such an advertisement is unilaterally sent from the sponsor's viewpoint rather than the user's viewpoint. However, in the present embodiment, it is possible to improve the interest of the user in the content that is not associated with the advertisement, and it is possible to display the advertisement from the user's viewpoint rather than the sponsor's viewpoint.

In the above-described embodiment, the notation “ . . . module” used for each component may be replaced with another notation such as “ . . . circuitry”, “ . . . assembly”, “ . . . device”, and “ . . . unit”.

The present disclosure can be implemented by software, hardware, or software in cooperation with hardware.

Note that the present disclosure may be implemented by a system, a device, a method, an integrated circuit, a computer program, or a recording medium, or may be implemented by any combination of a system, a device, a method, an integrated circuit, a computer program, and a recording medium. The program product is a computer-readable medium on which a computer program is recorded.

In addition, a program in which some procedures or all procedures are recorded can be provided after being recorded in a recording medium, can be provided as an information processing device having a computer configuration after being stored in a read only memory (ROM), or can be downloaded via a network and executed by a computer. A central processing unit (CPU) of the computer executes processing by reading and executing a program.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A content display method of a display device including:
a display having a predetermined shape and having a predetermined side along a first direction; and
a touch panel arranged to overlap the display and configured to receive a touch operation,
the content display method comprising:
displaying a first content on the display;
receiving a first touch operation along the first direction on the touch panel;
moving the first content along the first direction and moving an index serving as a second content related to the first content along the first direction near the predetermined side, on the display;
receiving a second touch operation along a second direction different from the first direction on the touch panel, the second touch operation starting from a position corresponding to the index; and
displaying the second content on the display.

2. The content display method according to claim 1, wherein
a direction of the first touch operation along the first direction, a direction of movement of the first content along the first direction, and a direction of movement of the index along the first direction are same.

3. The content display method according to claim 1, wherein
the index is smaller than the display.

4. The content display method according to claim 2, wherein
the index is smaller than the display.

5. The content display method according to claim 1, wherein
the index has a triangular shape.

6. The content display method according to claim 2, wherein
the index has a triangular shape.

7. The content display method according to claim 1, wherein
the index is arranged in contact with the predetermined side.

8. The content display method according to claim 2, wherein
the index is arranged in contact with the predetermined side.

9. The content display method according to claim 1, wherein
the predetermined side includes a first side and a second side opposite to the first side, and
the index is displayed near the first side and/or near the second side.

10. The content display method according to claim 2, wherein
the predetermined side includes a first side and a second side opposite to the first side, and
the index is displayed near the first side and/or near the second side.

11. The content display method according to claim 1, wherein
the predetermined shape of the display includes a rectangle, and
the predetermined side includes a rectangle long side.

12. The content display method according to claim 2, wherein
the predetermined shape of the display includes a rectangle, and
the predetermined side includes a rectangle long side.

13. The content display method according to claim 1, wherein
the first content includes at least a character, and
the second content includes at least an image.

14. The content display method according to claim 2, wherein
the first content includes at least a character, and
the second content includes at least an image.

15. The content display method according to claim 13, further comprising:
receiving an input of the character serving as the first content on the touch panel.

16. The content display method according to claim 14, further comprising:
receiving an input of the character serving as the first content on the touch panel.

17. The content display method according to claim 1, wherein
a size of the index serving as the second content is dynamically switched.

18. The content display method according to claim 1, wherein
a residence time of the index serving as the second content varies.

19. The content display method according to claim 1, wherein
the index serving as the second content is hidden when a valid period of the index has expired or a relation of the index has broken.

20. The content display method according to claim 1, wherein
the index serving as the second content is re-displayed based on the first content re-displayed by the first touch operation along the first direction.
